(19) United States
(12) Patent Application Publication
(10) Pub. No.: US 2003/0011644 A1
(43) Pub. Date: Jan. 16, 2003

(54) Digital imaging systems with user intent-based functionality

(76) Inventors: Linda Bilsing, Masonville, CO (US); Bruce Votipka, Fort Collins, CO (US); Sharon Kurz, Greeley, CO (US)

Correspondence Address: HEWLETT-PACKARD COMPANY, Intellectual Property Administration, P.O. Box 272400, Fort Collins, CO, 80527-2400, US

(21) Appl. No.: 09/903,331

(22) Filed: Jul. 11, 2001

(51) Int. Cl. G06F 3/00; G06F 13/00

(52) U.S. Cl. 345/812

(57) ABSTRACT

Imaging systems that provide intent-based functionality are provided. A representative imaging system includes an intent-based image acquisition system configured to receive digital image data corresponding to a captured image and a user input corresponding to an intended use of the digital image data. The intent-based image acquisition system is further configured to alter a format of the digital image data in response to the user input so that the format corresponds to the intended use of the digital image data. Methods and computer readable media also are provided.

### BACKGROUND OF THE INVENTION

1. Technical Field

The present invention generally relates to digital imaging and, more specifically, to such systems and methods that provide intent-based functionality.

2. Description of the Related Art

Image-capturing devices, such as scanners, digital cameras, and multi-function devices, for example, are common-place peripheral devices for acquiring digital image data. For instance, a scanner may be utilized for acquiring image data corresponding to a document. Once acquired, such image data may be modified and/or formatted so that it is suitable for various uses. By way of example, if the image data is to be inserted as text into another document, the scanned image may be processed by optical character recognition (OCR) software. If, however, the image data is to be e-mailed, for example, the image data may be saved as an image file, such as jpg, for example. Scanners, digital cameras, and multi-function devices are known that facilitate these functional tasks.

As depicted in FIG. 1, a representative prior art scanner 100 includes a front panel 102. The front panel is configured to provide a user with one or more functional selections from which to choose. In FIG. 1, each functional selection is associated with a specific hardware button or actuator. So configured, a user desiring to perform a particular function depresses or, otherwise, actuates the button corresponding to the desired function. For instance, front panel 102 provides button 104 corresponding to a copy function, button 106 corresponding to a e-mail function, button 108 corresponding to a fax function, and button 110 corresponding to a document function. So configured, front panel 102 provides a user with a visual indication of discrete functions that may be facilitated by the scanner. However, such a front panel does not provide the user with the ability to scan or, otherwise, acquire image data and provide the image data in a format that is particularly adapted to facilitate the user's intent.

Therefore, there is a need for improved systems and methods that address these and/or other shortcomings of the prior art.

### SUMMARY OF THE INVENTION

Briefly described, the present invention relates to digital imaging. In this regard, embodiments of the invention may be construed as imaging systems. In a representative embodiment, the imaging system includes an intent-based image acquisition system configured to receive digital image data corresponding to a captured image and a user input corresponding to an intended use of the digital image data. The intent-based image acquisition system is further configured to alter a format of the digital image data in response to the user input so that the format corresponds to the intended use of the digital image data.

Embodiments of the invention also may be construed as methods for providing image data. A representative method includes the steps of: (1) receiving digital image data corresponding to a captured image; (2) receiving a user input corresponding to an intended use of the digital image data; and (3) altering a format of the digital image data in response to the user input such that the format corresponds to the intended use of the digital image data.

Other embodiments of the invention may be construed as computer readable media. In this regard, a representative computer readable medium includes: (1) logic configured to receive digital image data corresponding to a captured image; (2) logic configured to receive a user input corresponding to an intended use of the digital image data; and (3) logic configured to alter a format of the digital image data in response to the user input such that the format corresponds to the intended use of the digital image data.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic view of a representative prior art scanning device.

FIG. 2 is a schematic diagram depicting an embodiment of the imaging system of the present invention.

FIG. 3 is a schematic diagram of a computer or processor-based system that may be utilized to implement the intent-based image acquisition system of the present invention.

FIG. 4 is a flowchart depicting representative functionality of the imaging system of FIGS. 2 and 3.

FIG. 5 is a flowchart depicting representative functionality of the imaging system of FIGS. 2 and 3.

FIG. 6 is a schematic diagram depicting a representative embodiment of an image-capturing device that may be utilized to implement the intent-based image acquisition system of FIGS. 2-4.

FIG. 7 is a representative embodiment of a graphical user interface that may be utilized to implement the intent-based image acquisition system of FIGS. 2-4.

FIG. 8 is a flowchart depicting representative functionality of the intent-based image acquisition system of FIGS. 2-4.

### DETAILED DESCRIPTION

As depicted in FIG. 2, a representative embodiment of the imaging system 200 of the present invention incorporates an intent-based image acquisition system 202. Intent-based image acquisition system 202 is configured to communicate with an image-capturing device 204, such as a scanner, digital camera, multi-function device, digital sender, or digital copier, for example, that is configured to provide digital data corresponding to a captured image. Optionally, intent-based image acquisition system 202 can be configured to communicate with a printer 206. Intent-based image acquisition system 202 also may be adapted to communicate, such as via a communications network 208, with one or more intended recipients of image data. Such a communications network may include one or more of the Internet, an intranet, and an ethernet, among others. By way of example, recipients 210, 212, and 214 are depicted in FIG. 2 as communicating with intent-based image acquisition system 202 via communications network 208. As described in greater detail hereinafter, imaging system 200 and, more specifically, intent-based image acquisition system 202 facilitates providing image data in various formats based upon the intent of the user. Thus, image data acquired by image-capturing device 204, e.g., a scanner, may be appropriately configured for printing and/or viewing. In particular, the image data may be appropriately configured for being sent as text via e-mail, as facsimile data, and as a photo(s) via e-mail, among others.

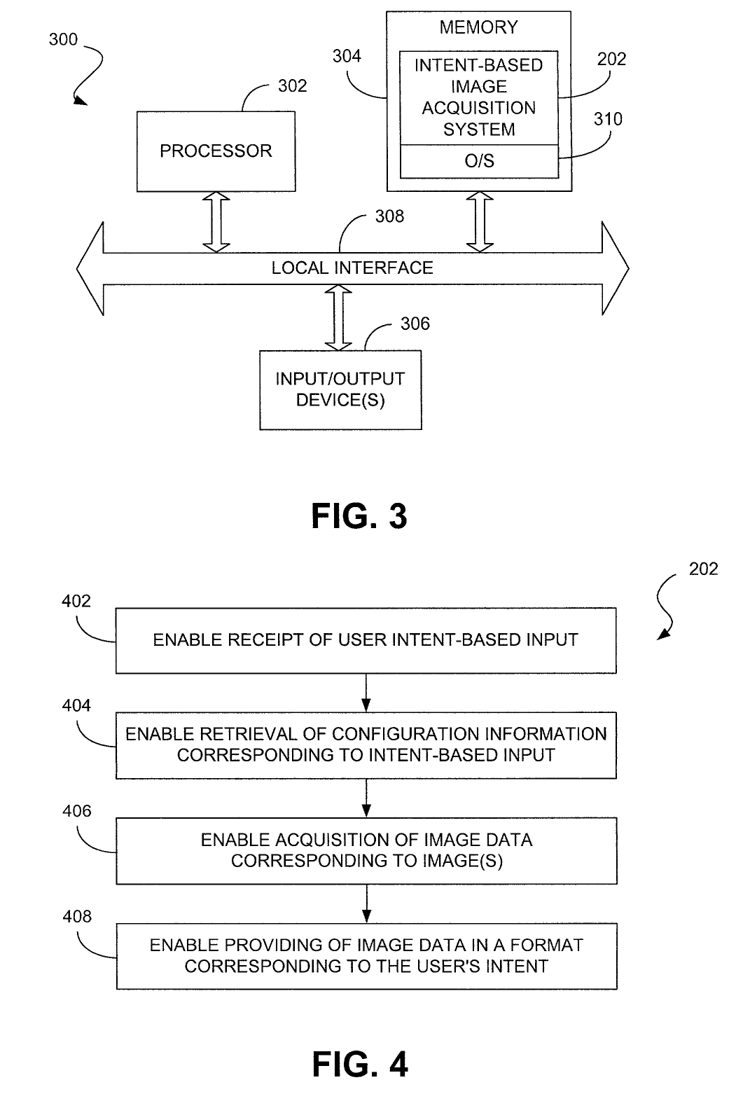

The intent-based image acquisition system of the present invention can be implemented in software, firmware, hardware, or a combination thereof. Preferably, the intent-based image acquisition system is implemented in software, as an executable program, and is executed by a special or general purpose digital computer, such as a personal computer, workstation, minicomputer, or mainframe computer. An example of a general purpose computer that can implement the intent-based image acquisition system of the present invention is shown in FIG. 3.

Generally, in terms of hardware architecture, as shown in FIG. 3, the computer 300 includes a processor 302, memory 304, and one or more input and/or output (I/O) devices 306 (or peripherals) that are communicatively coupled via a local interface 308. The local interface 308 can be, for example but not limited to, one or more buses or other wired or wireless connections, as is known in the art. The local interface 308 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 302 may be a hardware device for executing software that can be stored in memory 304. The processor 302 can be any custom made or commercially available processor, a central processing unit (CPU) or an auxiliary processor among several processors associated with the computer 300, and a semiconductor based microprocessor (in the form of a microchip) or a macroprocessor.

The memory 304 can include any one or combination of volatile memory elements (e.g., random access memory (RAM, such as DRAM, SRAM, etc.)) and nonvolatile memory elements (e.g., ROM, hard drive, tape, CDROM, etc.). Moreover, the memory 304 may incorporate electronic, magnetic, optical, and/or other types of storage media. Note that the memory 304 can have a distributed architecture, where various components are situated remote from one another, but can be accessed by the processor 302.

The software in memory 304 may include one or more separate programs, each of which comprises an ordered listing of executable instructions for implementing logical functions. In the example of FIG. 3, the software in the memory 304 includes the intent-based image acquisition system 202 and an operating system (O/S) 310. The operating system 310 essentially controls the execution of other computer programs, such as the intent-based scanning system, and provides scheduling, input-output control, file and data management, memory management, and communication control and related services.

The intent-based image acquisition system 202 may be a source program, executable program (object code), script, or any other entity comprising a set of instructions to be performed. When a source program, then the program needs to be translated via a compiler, assembler, interpreter, or the like, which may or may not be included within the memory 304, so as to operate properly in connection with the O/S 310. Furthermore, the intent-based image acquisition system can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 306 may include input devices, for example but not limited to, a keyboard, mouse, scanner, digital camera, multi-function device, digital sender, microphone, etc. Furthermore, the I/O devices 306 may also include output devices, for example but not limited to, a printer, display, etc. Finally, the I/O devices 306 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 300 is a PC, workstation, or the like, the software in the memory 304 may further include a basic input output system (BIOS) (omitted for simplicity). The BIOS is a set of essential software routines that initialize and test hardware at startup, start the O/S 310, and support the transfer of data among the hardware devices. The BIOS is stored in ROM so that the BIOS can be executed when the computer 300 is activated.

When the computer 300 is in operation, the processor 302 is configured to execute software stored within the memory 304, to communicate data to and from the memory 304, and to generally control operations of the computer 300 pursuant to the software. The intent-based image acquisition system 202 and the O/S 310, in whole or in part, but typically the latter, are read by the processor 302, perhaps buffered within the processor 302, and then executed.

When the intent-based image acquisition system 202 is implemented in software, as is shown in FIG. 3, it should be noted that the intent-based image acquisition system can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The intent-based image acquisition system 202 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the intent-based image acquisition system is implemented in hardware, the intent-based image acquisition system can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The flowchart of FIG. 4 shows the functionality of a representative implementation of the intent-based image acquisition system. In this regard, each block of the flowchart represents a module segment or portion of code which comprises one or more executable instructions for implementing the specified logical function or functions. It should also be noted that in some alternative implementations the functions noted in the various blocks may occur out of the order depicted in the flowcharts of FIGS. 4, 5 and 8. For example, two blocks shown in succession in FIG. 4 may, in fact, be executed substantially concurrently. Alternatively, the blocks may sometimes be executed in the reverse order depending upon the functionality involved.

As depicted in FIG. 4, the functionality of a representative embodiment of the intent-based image acquisition system or method 202 may be construed as beginning at block 402 where receipt of an intent-based input from a user is enabled. In block 404, the intent-based image acquisition system enables retrieval of image configuration (settings) information corresponding to the user's intent. Thereafter, such as depicted in block 406, acquisition of image information corresponding to a image(s) to be acquired is enabled. In block 408, the system enables image data, which is particularly configured based upon the user's intent, to be provided.

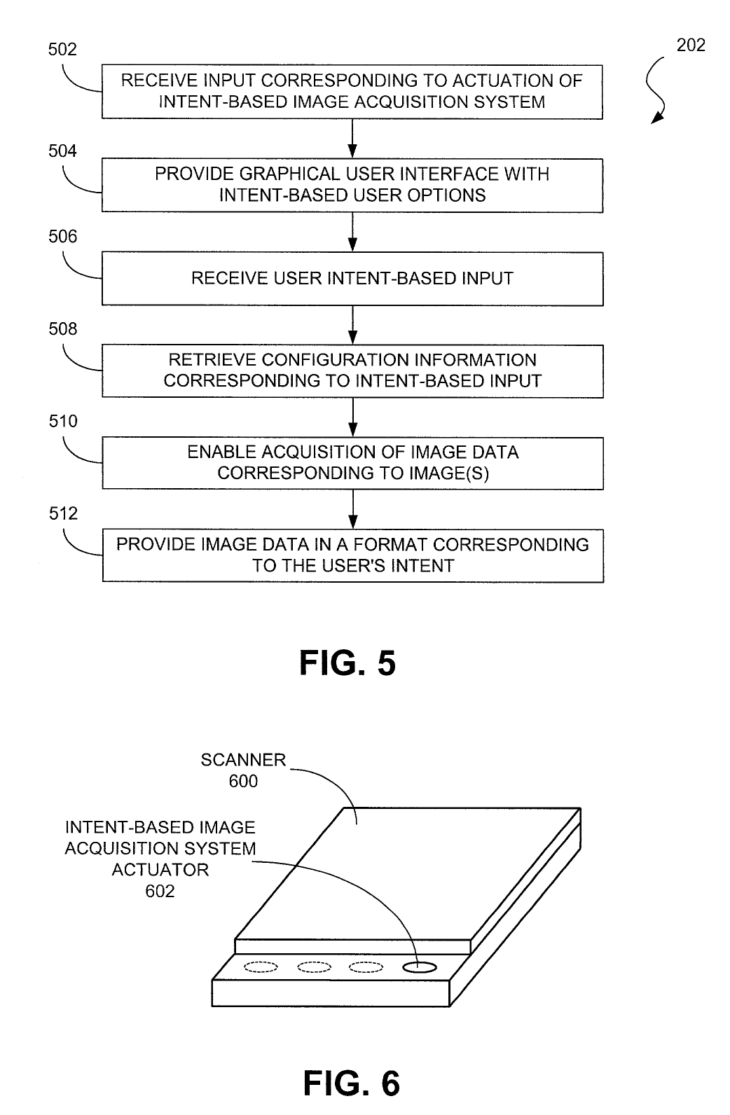

An alternative embodiment of the intent-based image acquisition system or method 202 is depicted in FIG. 5. As shown therein, the system or method 202 may be construed as beginning at block 502 where an input corresponding to actuation of the intent-based image acquisition system is received. In response thereto, a user may be provided with a graphical user interface that includes one or more intent-based options from which to choose (block 504). In block 506, a user intent-based input is received. Thereafter, such as depicted in block 508, configuration information corresponding to the intent-based input is retrieved. In block 510, acquisition of image data corresponding to an image(s) is enabled. Then, such as depicted in block 512, image data may be provided to the user in a format corresponding to the user's intent.

In FIG. 6, a representative image-capturing device 600, e.g., a scanner, is provided that may facilitate the aforementioned functionality of the intent-based image acquisition system. It should be noted that although image capturing device 600 is described here as a scanner, various other configurations are contemplated, including digital cameras, multi-function devices, digital senders, digital copiers and/or other devices that are capable of acquiring digital image data.

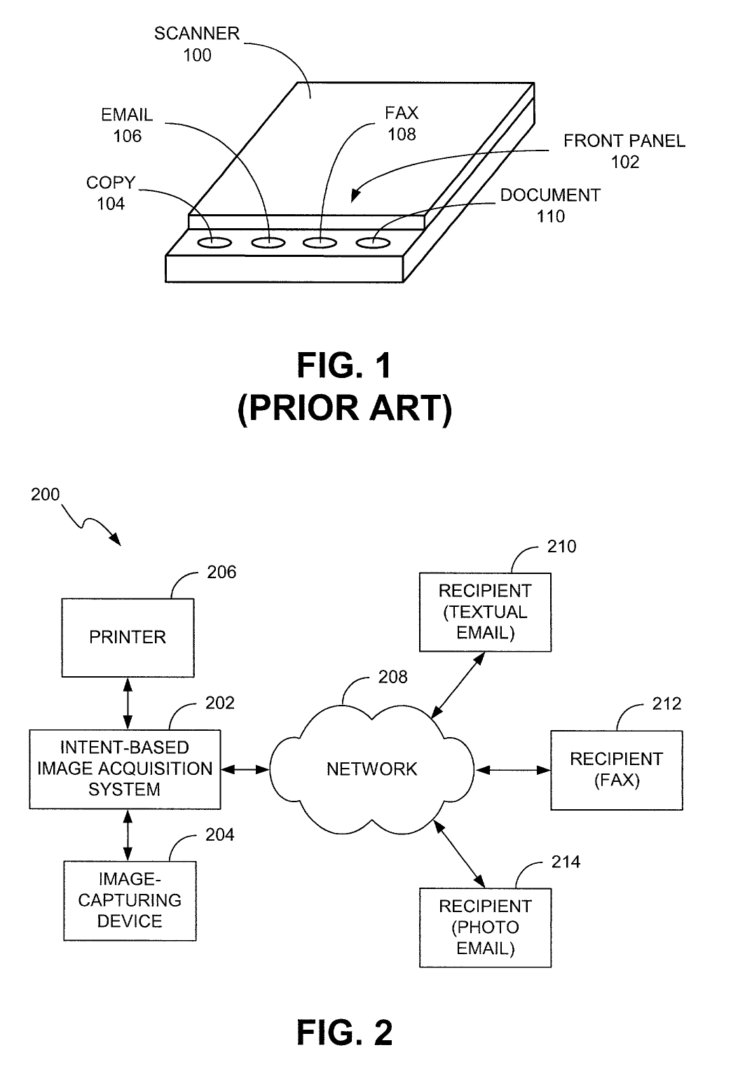

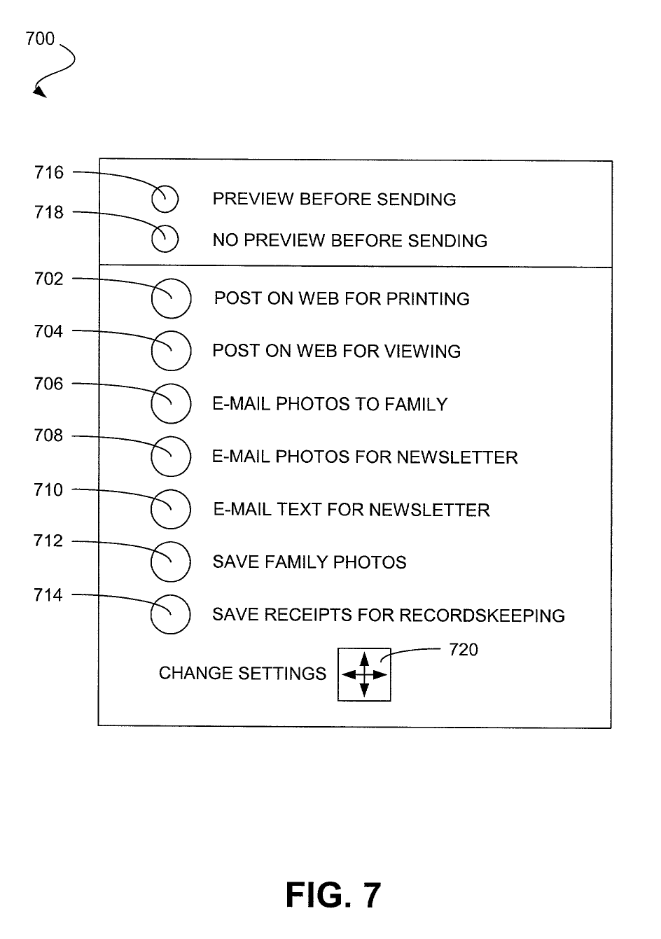

Scanner 600 may incorporate an intent-based image acquisition system button or actuator 602. In response to receiving a signal corresponding to actuation of button 602, the intent-based image acquisition system (FIGS. 2 and 3) may provide the user with a graphical user interface, such as user interface 700 depicted in FIG. 7. The user interface may be displayed to the user via a display device (not shown in FIG. 6). So provided, the user is presented with a variety of intent-based operation selections that are conveniently accessible by the user. In this manner, the intent-based image acquisition system facilitates utilization of scanning support software/products about which the user may, otherwise, be unaware (described in detail hereinafter). It should be noted that in addition to button 602, scanner 600 may incorporate various conventional (function-based) actuators, such as those described hereinbefore in relation to scanner 100 of FIG. 1.

Referring now to FIG. 7, an embodiment of a graphical user interface provided by the intent-based image acquisition system will be described in greater detail. As depicted in FIG. 7, user interface 700 provides a user with the ability to select various image capture options. In particular, the embodiment depicted in FIG. 7 provides actuators 702, 704, 706, 708, 710, 712, and 714. These actuators are referred to as “intent-based” actuators. Additionally, other actuators such as 716, 718, and 720 may be provided and will be described in greater detail hereinafter.

Referring now the intent-based actuators, e.g., actuators 702-714, these actuators may be adapted to enable image data to be provided in a variety of formats based upon the user's intent. More specifically, actuator 702, upon actuation, is adapted to facilitate posting of image data on a Web site when that image data is to be printed. By way of example, when actuator 702 is actuated, image data may be provided in a file(s) that is particularly sized for downloading. Additionally, the image data may be formatted for use on a Web page, characterized by a suitable printer resolution, and/or grayscale enabled so as to be suitable for printing by black and white printers, among others.

Button 704, upon actuation, is adapted to facilitate posting of image data on a Web site for viewing. More specifically, image data may be provided in a file that is particularly sized for convenient downloading. Additionally, the image data may be provided in an appropriate file format, e.g., jpg, configured with a suitable screen resolution so as to enable viewing of the entire image on one screen, for example. Moreover, creation of a thumbnail image, among others, also may be enabled.

Button 706, upon actuation, is adapted to facilitate e-mailing of a photo(s) to a recipient, such as a family member, for example. More specifically, image data may be particularly suited for viewing on a display screen of a display device, such as by being provided in a file that is sized for relatively fast e-mailing. Additionally, the image data may be provided in an appropriately selected screen resolution and/or in a file format that is conventionally utilized by multiple computer systems, among others. Thus, in this example, image quality may be traded off for faster speed so as to support the user's intent. More specifically, the user's intent of providing photographs for viewing by family members, for example, may be facilitated by enabling relatively fast transmission and/or access to image data corresponding to the acquired images.

Button 708, upon actuation, is adapted to facilitate e-mailing of photos for use in a newsletter, for example. More specifically, image data may be particularly adapted for inclusion in a printed newsletter. In particular, the image data may be provided in a file format preferred by commercial printing services, such as a file format that supports high-end printer resolution. Thus, in this example, speed may be traded off for higher image quality so as to support the user's intent. More specifically, higher image quality may be provided to facilitate the user's intent of the acquired images being printed at a high-end printer resolution.

Button 710, upon actuation, is adapted to facilitate e-mailing of text for newsletters, for example. More specifically, image data corresponding to a digitized document(s) may be particularly configured for incorporation into the body text of a newsletter, for example. In particular, the text may be recorded for OCR so that editing of the data may be conveniently facilitated. Additionally, the image data may be provided in a .txt file format, for example.

Button 712, upon actuation, is adapted to facilitate saving or archiving of photographs. More specifically, image data corresponding to one or more photographs may be provided in a format that is suitable for multiple uses by multiple family members, for example. More specifically, the photo(s) may be digitized at a high-resolution that can be compressed at a later time, if needed, so as to facilitate convenient sharing of files.

Button 714, upon actuation, is adapted to facilitate saving of receipts, for example, for record keeping. More specifically, image data corresponding to a document(s) may be provided in a format that is configured for archival purposes. In particular, the image data may be provided in a reduced file size, a relatively lower image resolution, and/or may be provided in an easy-to-access file format. So configured, the image data may be more readily suited for long term storage.

The non-intent-based actuators, e.g., buttons 716 and 718, may alternately facilitate previewing of acquired image data or no previewing of acquired image data prior to utilizing the image data as intended. Button 720, the “change settings” actuator, may, upon actuation, enable a user to establish desired configurations or settings for one or more user definable actuators. More specifically, in some embodiments, a user may add one or more actuators and/or remove one or more of the provided actuators so that the graphical user interface can be more appropriately adapted to facilitate a user's intent. Button 720 also may facilitate modifying configurations associated with a previously provided actuator. In particular, upon actuation of button 720, a user may change the configuration settings associated with actuator 702, for example. For instance, a user may modify the image data configuration provided by button 702 so that a higher resolution is utilized.

It should be noted that, in some embodiments, the intent-based image acquisition system and, more specifically, a graphical user interface provided by that system, may be adapted to accommodate the needs of various users. In particular, a graphical user interface is provided by the intent based image acquisition system may be particularly configured to support intent-based operations typically desired by a particular profession, hobbyist, etc. For example, functionality provided by the intent-based image acquisition system could be configured so as to accommodate needs of the insurance industry, for example. In such an embodiment, one or more actuators provided by a graphical user interface of the system may correspond to capturing images typically required for documenting insurance claims, for example. Thus, when a user associated with an insurance company intends to capture image data corresponding to a required insurance claim, the information may be provided in a format that is particularly suited for documenting such a claim.

In another representative embodiment, the intent-based image acquisition system may be adapted to accommodate the intent of a hobbyist, such as those engaged in genealogical studies, for example. In these embodiments, one or more actuators may be provided for improving image quality of captured photos, such as by reducing scratches and/or folds, capturing handwritten text, providing family trees in OCR formats, etc. Thus, although some embodiments of the present invention may be configured by a user so as to accommodate the particular needs of that user, various embodiments of the invention also may be provided that are particularly adapted to accommodate a user's desires.

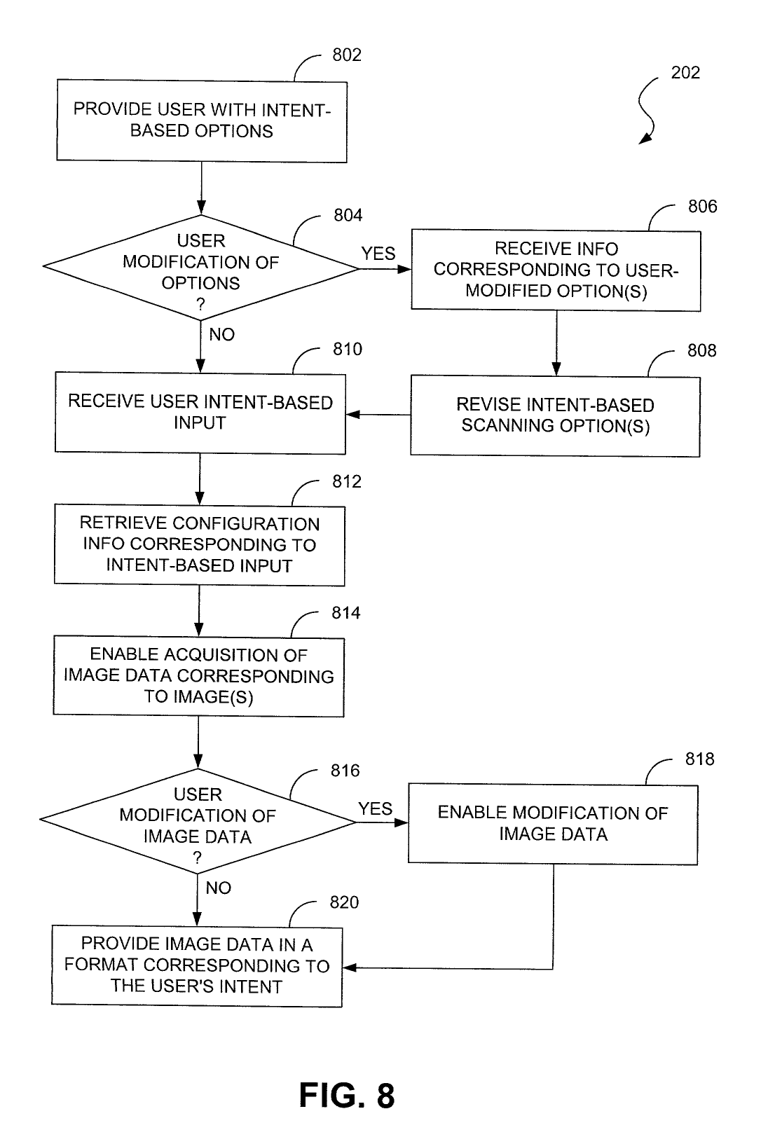

In FIG. 8, functionality of an alternative embodiment of the present invention is depicted. More specifically, this embodiment of the intent-based image acquisition system or method may be construed as beginning at block 802 where a user is provided with one or more intent-based options or selections from which to choose. By way of example, the intent-based selections may be provided to a user via a graphical user interface, such as user interface 700 depicted in FIG. 7. In block 804, a determination may be made as to whether the user desires to modify the intent-based selections provided to the user. If it is determined that the user desires to modify the intent-based selections, the process preferably proceeds to block 806 where information corresponding to desired user configuration settings is received. In block 808, the previously provided selections may be revised based upon the information received. Thereafter, the process may proceed to block 810.

If it was determined that the user does not desire to modify the intent-based selections, the process also preferably proceeds to block 810. In block 810, user intent-based input is received. Thereafter, such as depicted in block 812, configuration information corresponding to the user's intent is retrieved. Based upon the retrieved configuration information, acquisition of image data corresponding to a document(s) is enabled (block 814).

In block 816, a determination may be made as to whether the user desires to modify the acquired image data. If it is determined that the user desires to modify the acquired image data, the process preferably proceeds to block 818, where modification of the image data is enabled. In some embodiments, this functionality may entail launching an application, e.g., support software. For instance, applications such as Hewlett-Packard Precisionscan Pro™, are known to facilitate modification of image data. In particular, the image data may be resized, reformatted or otherwise reconfigured. After appropriate modification or if it was determined (in block 816) that the user did not desire to modify the acquired image data, the process preferably proceeds to block 818 where the image data is provided for use as intended.

1. An imaging system comprising:
an intent-based image acquisition system configured to receive digital image data corresponding to a captured image and a user input corresponding to an intended use of the digital image data, said intent-based image acquisition system being further configured to alter a format of the digital image data in response to said user input such that said format corresponds to the intended use of the digital image data.

2. The imaging system of claim 1, wherein said intent-based image acquisition system is configured to provide the user with a graphical user interface, said graphical user interface being configured to display to the user a plurality of intent-based selections from which to choose, each of said intent-based selections corresponding to an intended use of the digital image data.

3. The imaging system of claim 1, further comprising:
an image-capturing device configured to electrically communicate with said intent-based image acquisition system, said image-capturing device having an intent-based image acquisition system actuator such that, in response to actuating said intent-based image acquisition system actuator, said intent-based image acquisition system provides intent-based selections to the user.

4. The imaging system of claim 2, wherein a first of said of intent-based selections is configured with format settings adapted to alter digital image data corresponding to a first intended use of the image data, and wherein said intent-based image acquisition system is further configured to enable modification of said format settings.

5. The imaging system of claim 2, wherein said graphical user interface is configured to enable a user to preview image data that has been formatted to correspond to an intended use of the digital image data.

6. The imaging system of claim 2, wherein said plurality of intent-based selections are selected from the group consisting of: posting the image data on a Web site for printing, posting the image data on a Web site for viewing, emailing photo for printing, emailing photo for viewing, and archiving image data.

7. The imaging system of claim 3, wherein said image-capturing device is selected from the group consisting of:
a scanner, a digital camera, a multi-function device, a digital sender, and a digital copier.

8. The imaging system of claim 1, wherein said intent-based image acquisition system is configured to launch an application, the application being configured to enable modification of the digital image data.

9. The imaging system of claim 1, wherein said intent-based image acquisition system further comprises:
means for enabling modification of the digital image data.

10. A method for providing image data comprising the steps of:
receiving digital image data corresponding to a captured image;
receiving a user input corresponding to an intended use of the digital image data; and
altering a format of the digital image data in response to the user input such that the format corresponds to the intended use of the digital image data.

11. The method of claim 10, further comprising the step of:
providing the user with a graphical user interface configured to display to the user a plurality of intent-based selections from which to choose, each of the intent-based selections corresponding to an intended use of the digital image data.

12. The method of claim 11, wherein the step of providing the user with a graphical user interface comprises the step of:
enabling the user to modify the intent-based selections such that a modified selection more appropriately corresponds to the user's intended use of the digital image data.

13. The method of claim 11, further comprising the step of:
enabling the user to preview image data that has been formatted to correspond to an intended use of the digital image data.

14. The method of claim 11, further comprising the step of:
enabling modification of the digital image data.

15. The method of claim 12, wherein the step of providing the user with a graphical user interface comprises the step of:
providing the user with a selection corresponding to the intention of e-mailing an acquired image to a recipient; and
automatically providing the image data at a screen resolution adapted for displaying the acquired image on a single screen of a display device in response to the user selecting the selection corresponding to the intention of e-mailing the acquired image to a recipient.

16. The method of claim 14, wherein the step of enabling modification of the digital image data comprises the step of:
launching an application configured to enable modification of the digital image data.

17. The method of claim 15, wherein the acquired image is a photo.

18. A computer readable medium having a computer program for providing image data, said computer readable medium comprising:
logic configured to receive digital image data corresponding to a captured image;
logic configured to receive a user input corresponding to an intended use of the digital image data; and
logic configured to alter a format of the digital image data in response to the user input such that the format corresponds to the intended use of the digital image data.

19. The computer readable medium of claim 18, further comprising:
logic configured to provide the user with a graphical user interface configured to display to the user a plurality of intent-based selections from which to choose, each of the intent-based selections corresponding to an intended use of the digital image data.

20. The computer readable medium of claim 18, further comprising:
logic configured to enable the user to preview image data that has been formatted to correspond to an intended use of the digital image data.

21. The computer readable medium of claim 18, further comprising:
logic configured to enable modification of the digital image data.
